(19) United States
(12) Patent Application Publication
(10) Pub. No.: US 2007/0021254 A1
(43) Pub. Date: Jan. 25, 2007

(54) Sprocket

(75) Inventor: Jun Sakaguchi, Ama-gun, Aichi-ken (JP)

Correspondence Address: BORGWARNER INC., 3850 HAMLIN ROAD, AUBURN HILLS, MI, 48326, US

(73) Assignee: BORGWARNER MORSE TEC JAPAN, K.K., Nabari-shi (JP)

(21) Appl. No.: 11/419,525

(22) Filed: May 22, 2006

(30) Foreign Application Priority Data
Jul. 1, 2005 (JP) 2005-193517

(51) Int. Cl. F16H 55/30

(52) U.S. Cl. 474/152; 474/903

(57) ABSTRACT

A sprocket more firmly fitted to the sprocket attachment surface of a shaft comprising a plurality of teeth formed around the outer periphery and a boss portion having a central through hole. Hard abrasive grains are adhered by the electro-deposition process to an end surface of the boss portion that contacts the sprocket attachment surface of the sprocket. When fastening the sprocket to the sprocket attachment surface of the shaft, the abrasive grains on the end surface easily plastically deform the sprocket attachment surface, forming irregularities on the sprocket attachment surface. Thereby, engagement of the end surface of the sprocket with the sprocket attachment surface of the shaft is strengthened. As a result, even a small-sized sprocket may be further firmly fitted to the sprocket attachment surface of the shaft.

### REFERENCE TO RELATED APPLICATIONS

This application claims an invention which was disclosed in Japanese application number 2005-193517, filed Jul. 1, 2005, entitled “SPROCKET.” The benefit under 35 USC§ 119(a) of the Japanese application is hereby claimed, and the aforementioned application is hereby incorporated herein by reference.

### BACKGROUND OF THE INVENTION

1. Field of the Invention

The invention pertains to the field of sprockets. More particularly, the invention pertains to an improvement in the structure of the sprocket that allows for a firm attachment to a fitting surface of a shaft.

2. Description of Related Art

Generally, silent chain power transmission devices in use for engine timing systems for automobiles are comprised of a crank sprocket mounted on a crankshaft, a cam sprocket mounted on a camshaft, and a silent chain wrapped around the crank sprocket and the cam sprocket. During operation, the rotation of the crankshaft causes the rotation of the camshaft through the rotations of the crank sprocket, the silent chain and the cam sprocket.

In such an engine timing system, each sprocket is typically pressed against and fitted to the attachment surface of the corresponding shaft by a screwing force of bolts. That is, the sprocket is fixedly attached to the attachment surface of the shaft only by the screwing force of the bolts.

In accordance with the recent size reduction of the timing system, sprockets have been reduced in size and thus the area of the attachment surface of the shaft for the sprocket tends to decrease. In such a case, a sufficient fastening force cannot be applied to the attachment surface of the shaft from the sprocket.

In order to solve this problem, Japanese patent application laid-open publication No. 2004-108508, by the present applicant shows forming a plurality of protrusions on the end surface of the boss portion of the sprocket.

In this case, when fastening the sprocket to the shaft, the protrusions of the boss portion of the sprocket plastically deform and bite into the attachment surface of the shaft, thereby forming irregularities on the attachment surface of the shaft. The convex protrusions on the boss portion of the sprocket firmly engage with the concave portions of the attachment surface of the shaft. As a result, the boss portion of the sprocket is firmly fixed to the attachment surface of the shaft.

The above-mentioned publication describes that the convex protrusions on the boss portion of the sprocket are formed for example, by a shot peening method. However, it is not easy to form convex portions of a high hardness on the boss surface of the sprocket by such a method, so that the convex portions adequately plastically deform the attachment surface of the shaft. Therefore, in the automotive industry, there is a need to couple the sprocket with the shaft more firmly.

Therefore is a need in the art for a sprocket that can be fixed to the attachment surface of the shaft more firmly even in the case of a small-sized sprocket.

### SUMMARY OF THE INVENTION

A sprocket according to the present invention includes a boss portion with a central through hole formed therein and an outer circumferential portion formed around the boss portion having a plurality of circumferentially spaced teeth. Hard abrasive grains are fixedly adhered to an end surface of the boss portion, which contacts a sprocket attachment surface of a shaft.

According to the present invention, when fastening the sprocket to the shaft, the hard abrasive grains on the end surface of the boss portion of the sprocket easily plastically deform the sprocket attachment surface of the shaft and forms irregularities on the sprocket attachment surface of the shaft. Thereby, engagement of the end surface of the boss portion of the sprocket with the sprocket attachment surface of the shaft is strengthened. As a result, even a small-sized sprocket is further firmly fitted to the sprocket attachment surface of the shaft. Moreover, in this case, slippage of the boss portion of the sprocket relative to the shaft is prevented, thereby achieving a keyless coupling or spline-less coupling.

The hard abrasive grains may be fixedly adhered to the end surface of the boss portion by electro-deposition process.

The hard abrasive grains may be made of diamond or CBN (i.e. Cubic Boron Nitride), which are called super abrasive grains.

The sprocket may be a crank sprocket that is mounted on a crankshaft in an engine camshaft timing system. Alternatively, the sprocket may be a cam sprocket that is mounted on a camshaft in an engine camshaft timing system.

### BRIEF DESCRIPTION OF THE DRAWINGS

FIG. 1 shows a schematic representation of a camshaft timing system incorporating a sprocket according to an embodiment of the present invention.

FIG. 2 shows a front elevational view of a crank sprocket according to an embodiment of the present invention.

FIG. 3 shows a longitudinal sectional view of FIG. 2 taken along line III-III.

FIG. 4 shows a fitting state of a crank sprocket to the crankshaft.

### DETAILED DESCRIPTION OF THE INVENTION

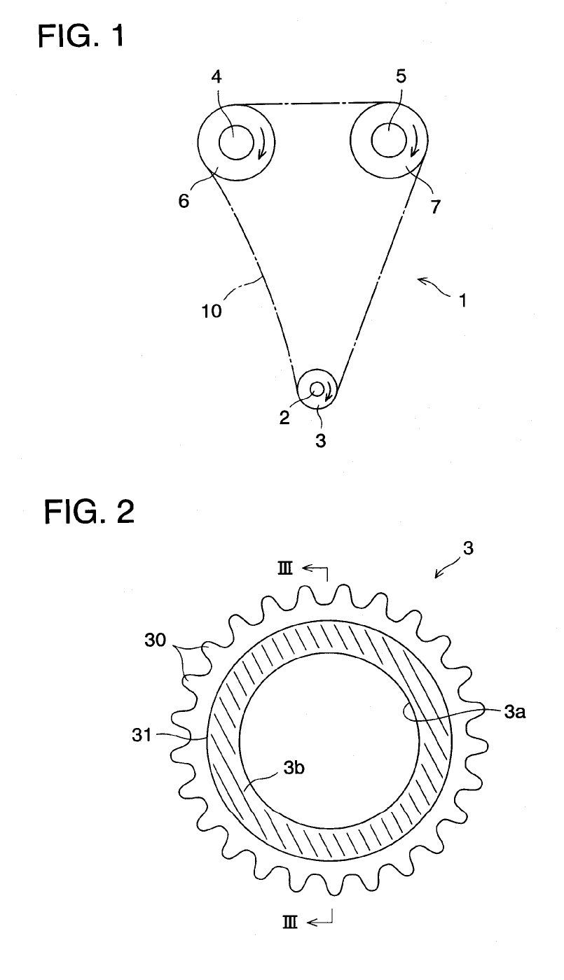

FIG. 1 shows an engine timing system employing a sprocket according to an embodiment of the present invention. As shown in FIG. 1, the engine timing system 1 includes a crankshaft 2, a crank sprocket 3 mounted on the crankshaft 2, two camshafts 4, 5, cam sprockets 6, 7 mounted on the camshafts 4, 5, respectively, and a chain 10 wrapped around the crank sprocket 3 and the cam sprockets 6, 7. A double overhead camshaft (DOHC) engine system is shown as an example.

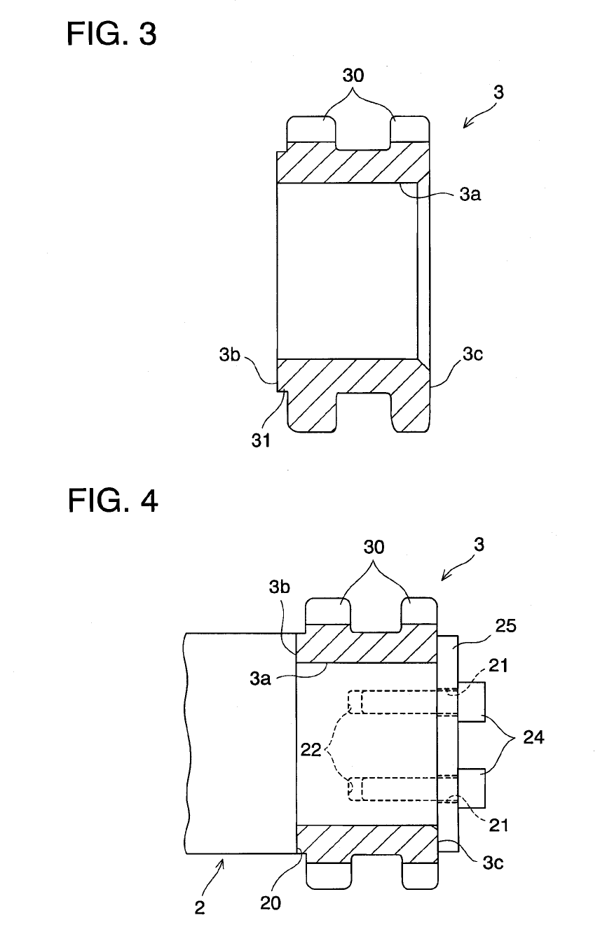

As shown in FIGS. 2 and 3, the crank sprocket 3 has an outer periphery with a plurality of circumferentially spaced teeth 30 and a boss portion 31 with a central through hole 3a formed therein for receiving the crankshaft 2.

The boss portion 31 has end surfaces 3b, 3c disposed on opposite sides thereof. On the end surface 3b that contacts the sprocket attachment surface 20 of the crankshaft 2 (see FIG. 4) hard abrasive grains indicated by the slanting lines of FIG. 2 are adhered. These grains may be attached to the end surface 3b contacting the sprocket attachment surface 20 by an electro-deposition procedure.

The hard abrasive grains are preferably grains of diamond or CBN (Cubic Boron Nitride) that are called super abrasive grains.

When fitting the crank sprocket 3 to the crankshaft 2, as shown in FIG. 4, the end of the crankshaft 2 is inserted into the central through hole 3a of the boss portion 31 of the crank sprocket 3 and the end surface 3b of the crank sprocket 3 is contacted by the sprocket attachment surface 20 of the crankshaft 2.

Then, an end plate 25 is disposed on the end portion of the crankshaft 2 and end bolts 24 are inserted into the through holes 21 formed in the end plate 25 and the threaded holes 22 formed in the end of the crankshaft 2. By screwing the end bolts 24 into the threaded holes 22, the end plate 25 is fastened to the end portion 3c, opposite from the end portion 3b in contact with the sprocket attachment surface 20 of the crankshaft 2.

As the end bolts 24 are screwed into the threaded holes 22, a fastening force of the end bolts 24 is transmitted to the crank sprocket 3 through the end plate 25. Thereby, the end surface 3b of the crank sprocket 3 presses against the sprocket attachment surface 20 of the crankshaft 2.

At this time, as above-mentioned, the end surface 3b of the crank sprocket 3 has hard abrasive grains adhered thereon by the electro-deposition process. Therefore, when the end surface 3b of the crank sprocket 3 presses against the sprocket attachment surface 20 of the crankshaft 2, the hard abrasive grains on the end surface 3b easily plastic-deform and bite into the sprocket attachment surface 20 of the crankshaft 2 and form irregularities on the sprocket attachment surface 20. In such a manner, the engagement of the boss end surface 3b with the sprocket attachment surface 20 may be strengthened by coupling of the protruded hard abrasive grains with the concave portions formed on the sprocket attachment surface 20 of the crankshaft 2. Thereby, even a small-sized sprocket with a small contact area with the crankshaft may be fitted firmly to the sprocket attachment surface of the shaft. Moreover, in this case, a slippage of the boss portion of the sprocket relative to the shaft may be prevented, thereby allowing for a keyless coupling or spline-less coupling.

Additionally, in the above-mentioned embodiment, the present invention was applied to the crank sprocket of the engine camshaft timing system, but the present invention may also be applied to the cam sprocket of an engine camshaft timing system.

Accordingly, it is to be understood that the embodiments of the invention herein described are merely illustrative of the application of the principles of the invention. Reference herein to details of the illustrated embodiments is not intended to limit the scope of the claims, which themselves recite those features regarded as essential to the invention.

What is claimed is:

1. A sprocket for connection to a shaft with a sprocket attachment surface comprising:
a boss portion having an end portion for contacting the sprocket attachment surface of the shaft and a central through hole formed therein;
a plurality of circumferentially spaced teeth formed around the boss portion; and
a plurality of hard abrasive grains adhered to the end portion of the boss portion;
wherein when the sprocket is fastened to the shaft, the hard abrasive grains on the boss portion deform the sprocket attachment surface of the shaft, such that irregularities on the sprocket attachment surface are formed, strengthening the engagement between the sprocket and the shaft.

2. The sprocket of claim 1, wherein the hard abrasive grains are adhered to the end portion by an electro-deposition process.

3. The sprocket of claim 1, wherein the hard abrasive grains are diamond abrasive grains.

4. The sprocket of claim 1, wherein the hard abrasive grains are cubic boron nitride (CBN).

5. The sprocket of claim 1, wherein the sprocket is a crank sprocket that is mounted on a crankshaft in an engine camshaft timing system.

6. The sprocket of claim 1, wherein the sprocket is a cam sprocket that is mounted on a camshaft in an engine camshaft timing system.

7. A method of attaching a shaft with a sprocket attachment surface to a sprocket comprising the steps of:
a) adhering hard abrasive grains to a first end portion of a boss portion of a sprocket;
b) inserting the shaft into a central through hole of the boss portion of the sprocket, such that a first end portion of the boss portion of the sprocket contacts the sprocket attachment surface of the shaft;
c) placing an end plate on a second end portion of the boss portion of the sprocket, opposite the first end portion of the boss portion; and
d) inserting and tightening bolts into holes defined by the end plate and the shaft, fastening the shaft to the sprocket;
wherein when the sprocket is fastened to the shaft, the hard abrasive grains on the first end portion of the boss portion deform the sprocket attachment surface of the shaft, such that irregularities on the sprocket attachment surface are formed, strengthening the engagement between the sprocket and the shaft.

8. The method of claim 7, wherein the hard abrasive grains are fixedly adhered to the first end portion by an electro-deposition process.

9. The method of claim 7, wherein the hard abrasive grains are diamond abrasive grains.

10. The method of claim 7, wherein the hard abrasive grains are cubic boron nitride (CBN).

11. The method of claim 7, wherein the sprocket is a crank sprocket that is mounted on a crankshaft in an engine camshaft timing system.

12. The method of claim 7, wherein the sprocket is a cam sprocket that is mounted on a camshaft in an engine camshaft timing system.
